(19) United States
(12) Patent Application Publication
(10) Pub. No.: US 2016/0132933 A1
(43) Pub. Date: May 12, 2016

(54) INFORMATION PROCESSING DEVICES, COMMUNICATION SYSTEM, COMMUNICATION METHOD, AND PROGRAM

(71) Applicant: SONY CORPORATION, Tokyo (JP)

(72) Inventors: Takushi KUNIHIRO, Tokyo (JP); Yoichiro SAKO, Tokyo (JP); Kazuyuki SAKODA, Chiba (JP); Makoto AKAGI, Kanagawa (JP); Kouichirou ONO, Tokyo (JP); Tomoya ONUMA, Shizuoka (JP); Katsuhito ISHIDA, Kanagawa (JP); Mitsuru TAKEHARA, Tokyo (JP); Kento SUZUKI, Kanagawa (JP)

(73) Assignee: SONY CORPORATION, Tokyo (JP)

(21) Appl. No.: 14/893,028

(22) PCT Filed: Apr. 7, 2014
(86) PCT No.: PCT/JP2014/060066

§ 371 Date: Nov. 20, 2015

(30) Foreign Application Priority Data
May 28, 2013 (JP) 2013-111421

(51) Int. Cl. G06Q 30/02; H04L 12/26; H04W 4/04

(52) U.S. Cl. CPC G06Q 30/0267; H04W 4/043; H04L 43/16; G06Q 30/0261

(57) ABSTRACT

Content is to be provided at an appropriate time.

An information processing device is an information processing device including a communication unit and a control unit. The communication unit receives and transmits content through wireless communication. After reception of content, the control unit performs control to transfer the content to another information processing device from a location where a predetermined condition based on the location of the first transmission of the content is satisfied, the other information processing device existing in a predetermined range that is based on the location.

### TECHNICAL FIELD

The present technology relates to information processing devices. More particularly, the present technology relates to information processing devices that receive and transmit data through wireless communication, a communication system, a communication method, and a program for causing a computer to implement the method.

### BACKGROUND ART

There have been wireless communication technologies for exchanging various kinds of data through wireless communication. For example, there is an information processing device (such as a smartphone having a Wi-Fi (a registered trade name) (Wireless Fidelity) function) that is connected to a nearby information processing device and communicates image data through wireless communication.

Also, there is a suggested advertising information distribution system in which advertising information about a shop is transmitted to a mobile terminal existing in the communication range of the shop, and the mobile terminal transfers the advertising information to mobile terminals existing outside the communication range of the shop (see Patent Document 1, for example).

### CITATION LIST

### Patent Document

### Patent Document 1: Japanese Patent Application Laid-open No. 2005-174103

### SUMMARY OF THE INVENTION

### Problems to be Solved by the Invention

By the above mentioned conventional technologies, it is possible to transfer content (advertising information) to a mobile terminal existing outside the communication range of a base station via another mobile terminal.

If content transfer is frequently performed between devices in such a case, wireless network congestion might occur, for example. Also, if content with a limited valid period or range (such as a coupon valid only on the day) is transferred, for example, the content transfer might become meaningless depending on the timing of the content transfer.

The present technology has been developed in view of those circumstances, and aims to provide content at an appropriate time.

### Solutions to Problems

The present technology has been developed to solve the above problems, and a first aspect thereof is an information processing device, a communication method for the device, and a program for causing a computer to implement the method. The information processing device includes: a communication unit that receives and transmits content through wireless communication; and a control unit that performs control to transfer the content to another information processing device from a location after reception of the content, the other information processing device existing in a predetermined range, the predetermined range being based on the location, a predetermined condition being satisfied at the location, the predetermined condition being based on the location of the first transmission of the content. Accordingly, after reception of content, the content is transferred to another information processing device from a location where the predetermined condition based on the location of the first transmission of the content is satisfied, the other information processing device existing in a predetermined range that is based on the location.

In the first aspect, the control unit may determine whether the information processing device exists at a location where the predetermined condition is satisfied based on information accompanying the content. Accordingly, a check is made to determine whether the predetermined condition is satisfied at a location based on information accompanying the content.

In the first aspect, the control unit may transfer the content to the other information processing device during the period from the time when the information processing device exists at a location where the predetermined condition is first satisfied till the time when the information processing device exists at a location where the predetermined condition is not satisfied. Accordingly, after the time when the information processing device exists at the location where the predetermined condition is first satisfied, the content is transferred to another information processing device until the time when the information processing device exists at a location where the predetermined condition is not satisfied.

In the first aspect, the control unit may determine whether the information processing device exists at a location where the predetermined condition is satisfied based on at least one of a first distance, a second distance, a first time, and a second time, the first distance being the distance from the location of the first transmission of the content, the second distance being the distance of movement of the information processing device from the location of the first transmission of the content, the first time being the time elapsed since the time of the first transmission of the content, the second time being the time elapsed since the time of the reception of the content. Accordingly, a check can be made to determine whether the information processing device exists at a location where the predetermined condition is satisfied based on at least one of the first distance, the second distance, the first time, and the second time.

In the first aspect, when at least one of the first distance, the second distance, the first time, and the second time is greater than a threshold value serving as a reference value, the control unit may determine that the information processing device exists at the location where the predetermined condition is first satisfied. Accordingly, when at least one of the first distance, the second distance, the first time, and the second time is greater than the threshold value serving as the reference value, the information processing device can be determined to exist at the location where the predetermined condition is first satisfied.

In the first aspect, when at least one of the number of times the content has been transferred, the distance from the location of the first transmission of the content, and the time elapsed since the time of the first transmission of the content is greater than a threshold value serving as a reference value, the control unit may determine that the information processing device exists at a location where the predetermined condition is not satisfied. Accordingly, when at least one of the number of times the content has been transferred, the distance from the location of the first transmission of the content, and the time elapsed since the time of the first transmission of the content is greater than the threshold value serving as the reference value, the information processing device can be determined to exist at a location where the predetermined condition is not satisfied.

In the first aspect, when determining that the information processing device exists at a location where the predetermined condition is not satisfied, the control unit may discard the content. Accordingly, when the information processing device is determined to exist at a location where the predetermined condition is not satisfied, the content is discarded.

In the first aspect, the control unit may perform control to add a bonus to the content based on information accompanying the content. Accordingly, a bonus is added to the content based on the information accompanying the content.

In the first aspect, the control unit may transfer the content after associating history information with the content, the history information being for identifying the transfer source. Accordingly, after the history information for identifying the transfer source is associated with the content, the content is transferred.

In the first aspect, when the history information associated with the content includes history information about the information processing device at a time of reception of the content, the control unit may discard the content. Accordingly, if the history information associated with the content includes history information about the information processing device at a time of reception of the content, the content is discarded.

A second aspect of the present technology is a communication system, a communication method for the system, and a program for causing a computer to implement the method. The communication system includes: a first information processing device that transfers content to a second information processing device through wireless communication from a location after receiving the content, the second information processing device existing in a predetermined range, the predetermined range being based on the location, a predetermined condition being satisfied at the location, the predetermined condition being based on the location of the first transmission of the content; and the second information processing device that transfers the content to another information processing device through wireless communication from a location after receiving the content from the first information processing device, the other information processing device existing in a predetermined range, the predetermined range being based on the location, the predetermined condition being satisfied at the location. Accordingly, the first information processing device transfers content to a second information processing device through wireless communication from a location after receiving the content, the second information processing device existing in a predetermined range, the predetermined range being based on the location, a predetermined condition being satisfied at the location, the predetermined condition being based on the location of the first transmission of the content. The second information processing device transfers the content to another information processing device through wireless communication from a location after receiving the content from the first information processing device, the other information processing device existing in a predetermined range, the predetermined range being based on the location, the predetermined condition being satisfied at the location.

### Effects of the Invention

According to the present technology, an excellent effect to provide content at an appropriate time can be achieved.

### BRIEF DESCRIPTION OF DRAWINGS

FIG. 1 is a diagram showing an example configuration of a communication system 10 according to an embodiment of the present technology.

FIG. 2 is a block diagram showing an example internal structure of an information processing device 100 according to the embodiment of the present technology.

FIG. 3 is a block diagram showing an example internal structure of an access point 210 according to the embodiment of the present technology.

FIG. 4 is a diagram showing an example of use of the communication system 10 according to the embodiment of the present technology.

FIG. 5 is a diagram showing an example of use of the communication system 10 according to the embodiment of the present technology.

FIG. 6 is a diagram showing an example of display of shop information (a shop information display screen 500) displayed on a display unit 142 according to the embodiment of the present technology.

FIG. 7 is a diagram schematically showing an example format of information 300 to be communicated between the respective devices constituting the communication system 10 according to the embodiment of the present technology.

FIG. 8 is a diagram schematically showing an example format of information to be communicated between the respective devices constituting the communication system 10 according to the embodiment of the present technology.

FIG. 9 is a diagram showing an example of movement in a case where the user 20 carrying the information processing device 100 moves around in a building according to the embodiment of the present technology.

FIG. 10 is a sequence chart showing an example of a communication process between the respective devices constituting the communication system 10 according to the embodiment of the present technology.

FIG. 11 is a sequence chart showing an example of a communication process between the respective devices constituting the communication system 10 according to the embodiment of the present technology.

FIG. 12 is a flowchart showing an example of the processing procedures in a communication process to be performed by the information processing device 100 according to the embodiment of the present technology.

FIG. 13 is a flowchart showing an example of the processing procedures in a communication process to be performed by an information processing device 101 according to the embodiment of the present technology.

### MODES FOR CARRYING OUT THE INVENTION

The following is a description of modes for carrying out the present technology (the modes will be hereinafter referred to as the embodiments). Explanation will be made in the following order.

1. Embodiment (communication control: an example where content is transferred when a predetermined condition is satisfied after the content is received)

### 1. Embodiment

### Example Configuration of a Communication System

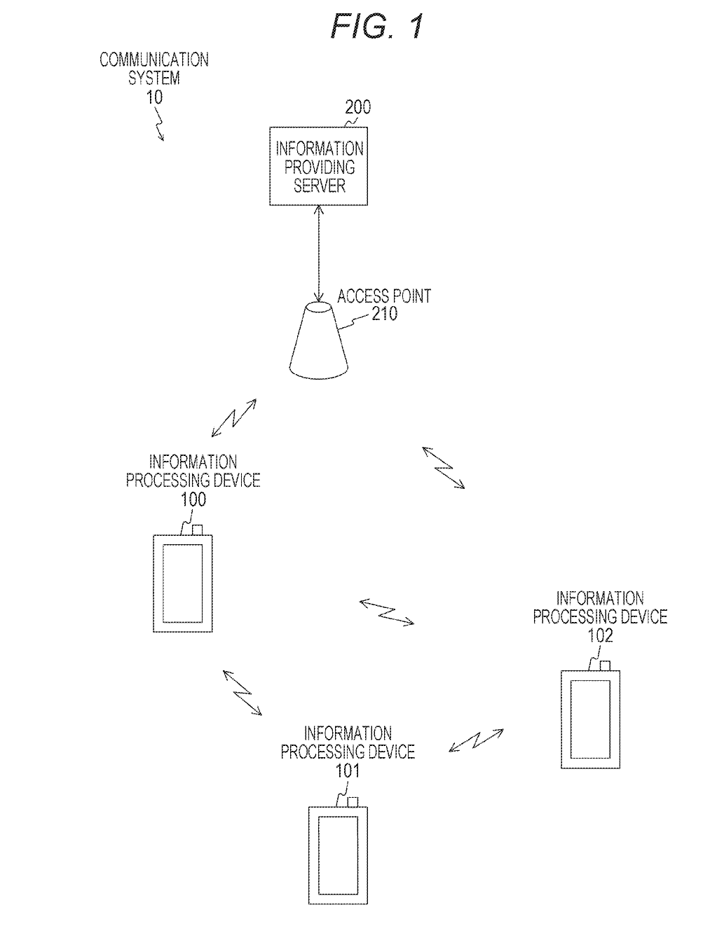

FIG. 1 is a diagram showing an example configuration of a communication system 10 according to an embodiment of the present technology.

The communication system 10 includes information processing devices 100 through 102, an information providing server 200, and an access point 210. The information processing device 100 is an example of the first information processing device of the claims. The information processing device 101 is an example of the second information processing device of the claims.

The information processing devices 100 through 102 are electronic devices having a wireless communication function (wireless communication devices such as portable telephone devices, smartphones, tablet terminals), for example. The information providing server 200 is a server that stores and manages various kinds of content (such as shop information (a product list of a shop, arrangement of products (an in-store map), and the like), product information such as bargain information, and coupons). The information providing server 200 provides the various kinds of content to the information processing devices 100 through 102 via the access point 210. In this manner, the information providing server 200 and the access point 210 are an example of a content output device (an information processing device) serving as a content transmission source.

Also, the information processing devices 100 through 102 and the access point 210 are wireless communication devices compliant with the IEEE (Institute of Electrical and Electronics Engineers) 802.11 specifications, for example. The information processing devices 100 through 102 and the access point 210 can exchange various kinds of information, using wireless communication functions. Also, any two of the information processing devices 100 through 102 can exchange various kinds of information, using wireless communication functions.

Here, a wireless LAN (Local Area Network) can be used in the wireless communication to be used by the communication system 10, for example. This wireless LAN may be Wi-Fi (a registered trade name) (Wireless Fidelity) Direct, TDLS (Tunneled Direct Link Setup), or an ad-hoc network, for example. As described above, in the embodiment of the present technology, a wireless LAN or the like that has a transmission band limited to a certain degree, for example, can be used in the wireless communication to be used by the communication system 10.

[Example Structure of Information Processing Device]

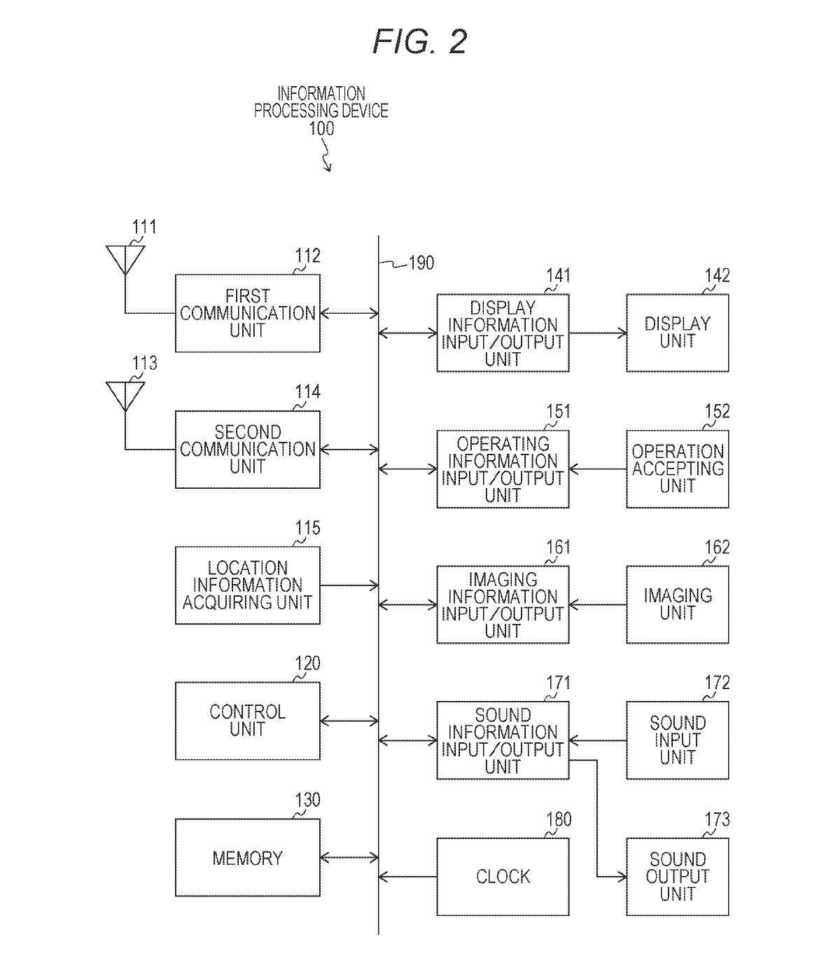

FIG. 2 is a block diagram showing an example internal structure of the information processing device 100 according to the embodiment of the present technology. Since the internal structures of the information processing devices 101 and 102 are the same as that of the information processing device 100, only the internal structure of the information processing device 100 will be described below, and explanation of the internal structures of the information processing devices 101 and 102 will not be provided.

The information processing device 100 includes antennas 111 and 113, a first communication unit 112, a second communication unit 114, a location information acquiring unit 115, a control unit 120, a memory 130, a display information input/output unit 141, and a display unit 142. The information processing device 100 also includes an operation information input/output unit 151, an operation accepting unit 152, an imaging information input/output unit 161, an imaging unit 162, a sound information input/output unit 171, a sound input unit 172, a sound output unit 173, and a clock 180. Also, these components are connected via a bus 190.

The first communication unit 112 is a module (a wireless LAN modem, for example) for transmitting and receiving radio waves via the antenna 111. For example, the first communication unit 112 can conduct wireless communication with a wireless LAN.

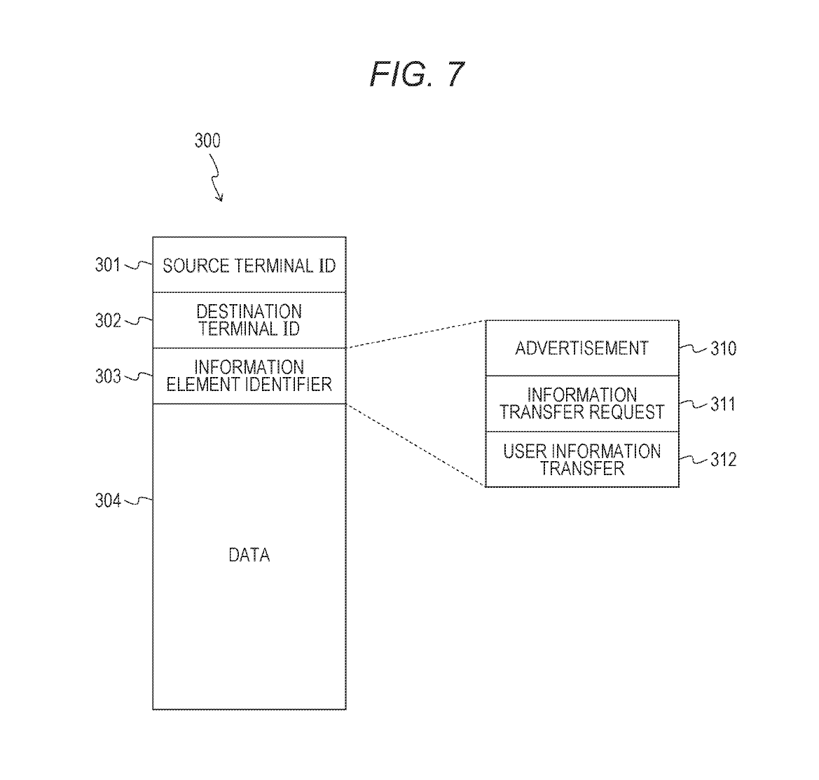

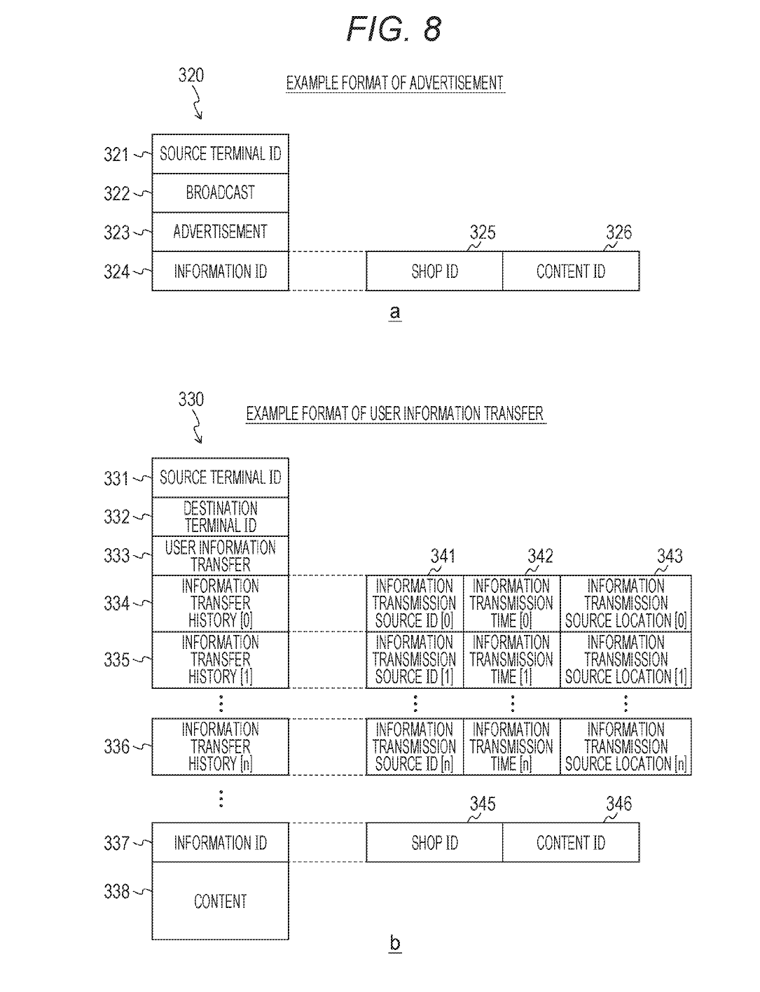

Under the control of the control unit 120, the first communication unit 112 receives and transmits respective pieces of information (such as the advertisement, the information transfer request, and the user information transfer shown in FIGS. 7 and 8) to and from another wireless communication device existing in a predetermined range, using wireless communication. Here, the predetermined range is a range having the location of the information processing device 100 as the reference position, for example, and the first communication unit 112 can perform data transmission and reception through wireless communication in that range. Another wireless communication device existing in the predetermined range is a wireless communication device existing near the information processing device 100, and such a wireless communication device can perform data transmission and reception to and from the information processing device 100 through wireless communication. Wireless communication may be performed with the use of a wireless communication function other than the above described wireless LAN. The first communication unit 112 is an example of the communication unit of the claims.

The second communication unit 114 is a module (a cellular modem, for example) for transmitting and receiving radio waves via the antenna 113. For example, the second communication unit 114 can perform wireless communication by 3G (3rd Generation) or LTE (Long Term Evolution) for communicating with a public wireless network.

The location information acquiring unit 115 acquires information (location information) for identifying the location where the information processing device 100 exists, and outputs the acquired location information to the control unit 120. This location information is absolute location information, such as latitude, longitude, and altitude. The location information acquiring unit 115 is realized by a GPS receiver that receives a GPS (Global Positioning System) signal, and calculates latitude, longitude, and altitude, for example. The location information acquiring unit 115 may acquire location information via an external network. For example, the location information acquiring unit 115 can acquire location information from another information processing device (such as a communication control unit being operated by a telecommunications carrier) via an external network. Also, the location information acquiring unit 115 can acquire information (location information) about the location corresponding to the identification information about a base station being operated by a telecommunications carrier or an access point of a wireless LAN, for example. The identification information about a base station for information processing devices is a cell ID, for example, and the identification information about an access point of a wireless LAN is an SSID (Service Set Identifier), for example. Location information may be acquired by any acquisition method other than the above acquisition methods.

The control unit 120 controls the respective components of the information processing device 100 in accordance with a control program stored in the memory 130. For example, the control unit 120 performs signal processing on transmitted and received information. The control unit 120 is realized a CPU (Central Processing Unit), for example.

The memory 130 is a memory that stores various kinds of information. For example, the memory 130 stores various kinds of information (such as a control program) required for the information processing device 100 to perform a desired operation. The memory 130 also stores various kinds of content such as content (content transmitted from the information providing server 200, for example).

In a case where data is transmitted through wireless communication, for example, the control unit 120 processes information read from the memory 130, a signal input from the operation accepting unit 152, or the like, and generates a packet of data to be actually transmitted (a transmission packet). The control unit 120 then outputs the generated transmission packet to the first communication unit 112. After converting the transmission packet into a format or the like of a communication method for actual transmission, the first communication unit 112 transmits the converted transmission packet to the outside from the antenna 111.

In a case where data is received through wireless communication, for example, the first communication unit 112 extracts a reception packet through a signal process performed by a receiver in the first communication unit 112 on a radio signal received via the antenna 111. The control unit 120 then interprets the extracted reception packet. If the data is determined to be held as a result of the interpretation, the control unit 120 writes the data into the memory 130.

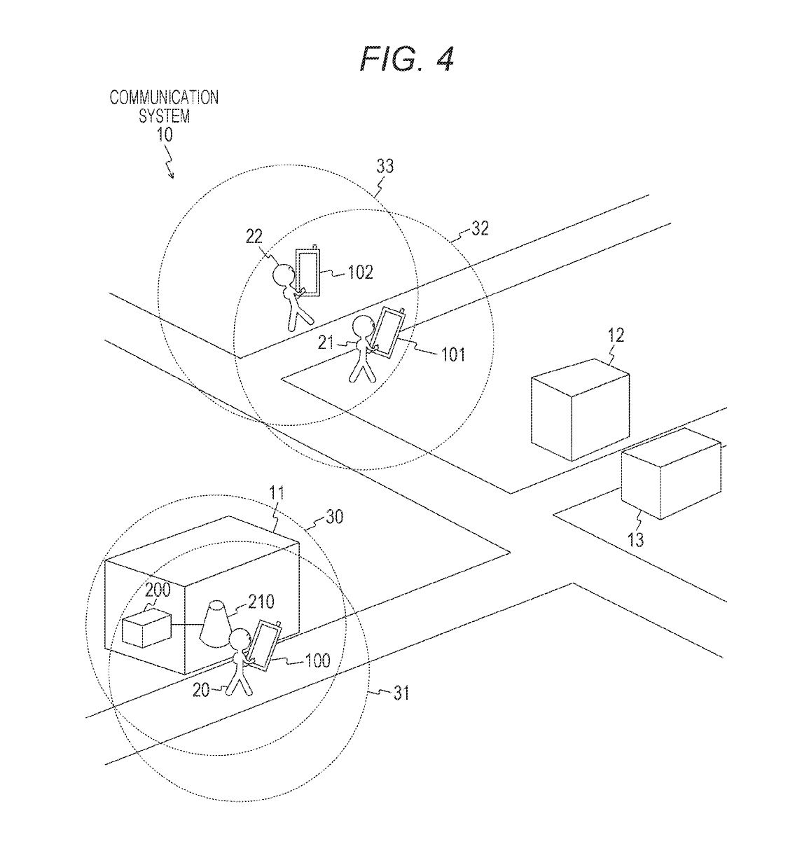

Also, the control unit 120 can provide various kinds of content stored in the memory 130 to another wireless communication device through wireless communication, for example. For example, after receiving content transmitted from the information providing server 200, the control unit 120 records the received content into the memory 130. The control unit 120 transmits the content when a predetermined condition is satisfied after the reception of the content. Examples of this transfer will be described in detail, with reference to FIGS. 4 through 11.

The control unit 120 can transfer received information to another information processing device in a communication mode that is a first mode or a second mode.

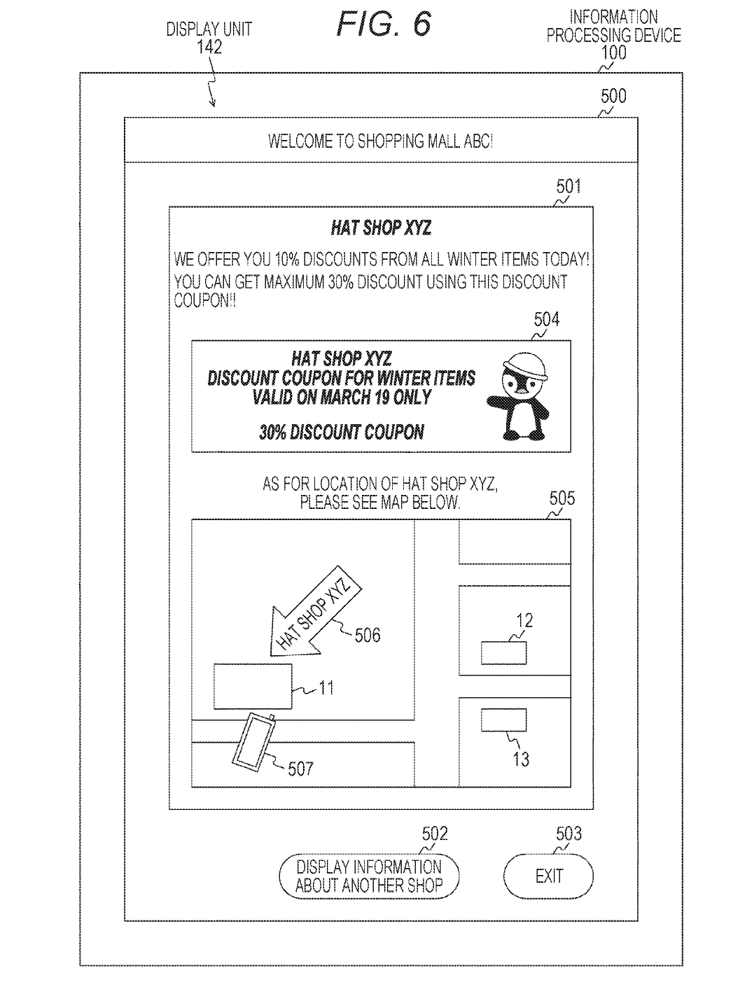

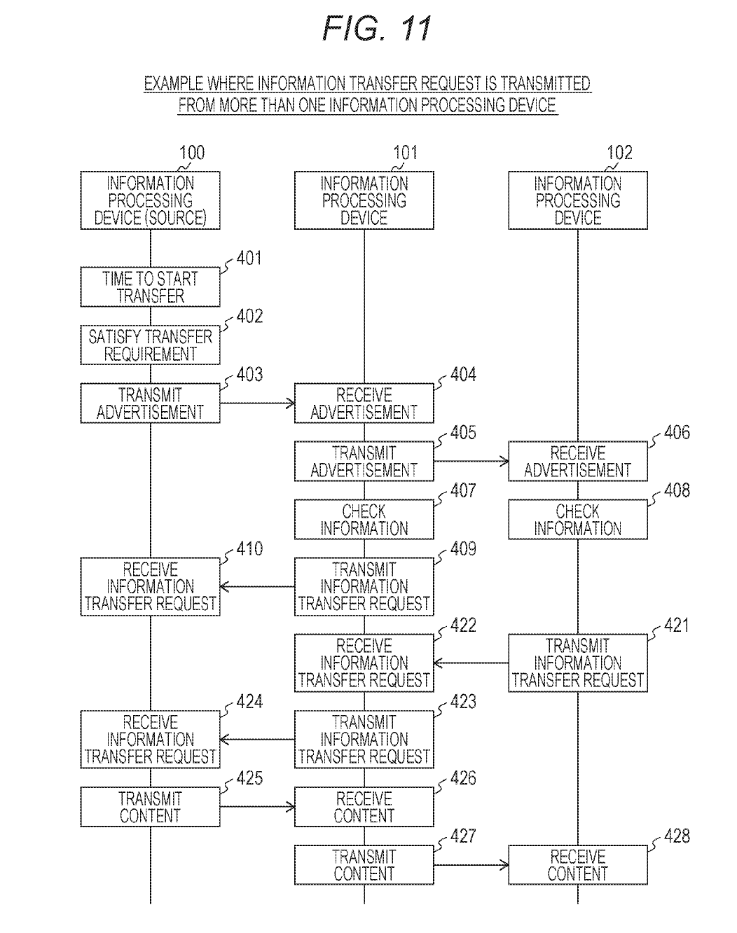

Here, the first mode is a communication mode for instantly transferring received information through wireless communication. The second mode is a communication mode for recording received information into the memory 130, and transferring the information recorded in the memory 130 through wireless communication when a predetermined condition is satisfied. In the first mode, received information is instantly recorded into the memory 130, but, after the recorded information is transferred, the transferred information is deleted from the memory 130. The first mode or the second mode may be set depending on the contents of received information, and the information may be then transferred. For example, in a case where received information is content (such as shop information for displaying the shop information display screen 500 shown in FIG. 6 (the content shown in FIG. 11 (425 through 428), for example), the second mode is set, and the content is then transferred. In a case where the received information is information other than content (such as the advertisement shown in FIG. 11 (403 through 406), or the information transfer request (409, 410, and 421 through 424)), the first mode is set, and the information is then instantly transferred. Alternatively, the first mode or the second mode may be set by a user operation, and information may be then transferred. In the embodiment of the present technology described below, the second mode is set only when received information is content, and the received content is transferred to another information processing device.

The display unit 142 is a display unit that displays various kinds of information (such as the shop information display screen 500 shown in FIG. 6) supplied via the display information input/output unit 141 under the control of the control unit 120. The display unit 142 may be a display panel such as an organic EL (Electro Luminescence) panel or an LCD (Liquid Crystal Display) panel.

The operation accepting unit 152 is an operation accepting unit that accepts an operation input performed by a user, and outputs the operation information corresponding to the accepted operation input to the control unit 120 via the operation information input/output unit 151. The operation accepting unit 152 is realized by a touch panel, a keyboard (or a virtual keyboard on a touch panel), or a mouse, for example. The operation accepting unit 152 and the display unit 142 can be integrally formed with a touch panel that allows a user to perform an operation input by touching the display surface with his/her finger or bringing his/her finger close to the display surface.

The imaging unit 162 generates image data (still image data or moving image data) by imaging an object under the control of the control unit 120, and outputs the generated image data to the control unit 120 via the imaging information input/output unit 161. The control unit 120 records the image data generated in this manner as image content (still image content or moving image content) into the memory 130. The imaging unit 162 is formed with an optical system (lenses), an imaging device, and a signal processing unit, for example. The imaging device may be a CCD (Charge Coupled Device) or a CMOS (Complementary Metal Oxide Semiconductor), for example.

The sound input unit 172 is a sound input unit (a microphone, for example) that acquires the sound around the information processing device 100, and outputs information about the acquired sound (sound information) to the control unit 120 via the sound information input/output unit 171.

The sound output unit 173 is a sound output unit (a speaker, for example) that outputs various kinds of sound supplied via the sound information input/output unit 171 under the control of the control unit 120.

The clock 180 acquires time information (the current time), and supplies the acquired time information to the control unit 120. In a case where a GPS receiver is used as the location information acquiring unit 115, the current time may be acquired based on a GPS signal.

[Example Structure of the Access Point]

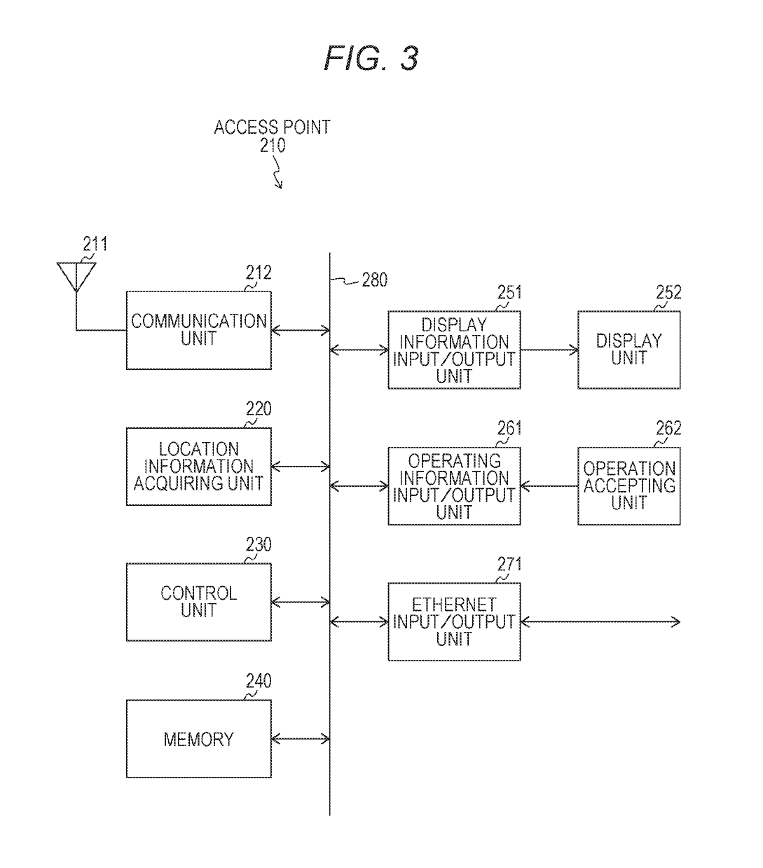

FIG. 3 is a block diagram showing an example internal structure of the access point 210 according to the embodiment of the present technology.

The access point 210 includes an antenna 211, a communication unit 212, a location information acquiring unit 220, a control unit 230, a memory 240, a display information input/output unit 251, and a display unit 252. The access point 210 also includes an operation information input/output unit 261, an operation accepting unit 262, and an Ethernet (a registered trade name) input/output unit 271. Also, these components are connected via a bus 280.

The antenna 211 and the communication unit 212 are equivalent to the antenna 111 and the first communication unit 112 shown in FIG. 2. The location information acquiring unit 220 is equivalent to the location information acquiring unit 115 shown in FIG. 2. The display information input/output unit 251 and the display unit 252 are equivalent to the display information input/output unit 141 and the display unit 142 shown in FIG. 2. Therefore, those components are not described in detail.

The control unit 230 controls the respective components of the information processing device 100 in accordance with a control program stored in the memory 240. For example, the control unit 230 performs signal processing on transmitted and received information. The control unit 230 is realized by a CPU, for example.

The memory 240 is a memory that stores various kinds of information. For example, the memory 240 stores various kinds of information (such as a control program) required for the access point 210 to perform a desired operation.

For example, using wireless communication, the control unit 230 can transmit various kinds of content provided from the information providing server 200 to another information processing device existing in a predetermined range having the location of the access point 210 as the reference position.

The operation accepting unit 262 is an operation accepting unit that accepts an operation input performed by a user, and outputs the operation information corresponding to the accepted operation input to the control unit 230 via the operation information input/output unit 261. The operation accepting unit 262 and the display unit 252 can be integrally formed with a touch panel that allows a user to perform an operation input by touching the display surface with his/her finger or bringing his/her finger close to the display surface.

The Ethernet input/output unit 271 functions as an Ethernet I/O (Input/Output) for connecting to an IP (Internet Protocol) network.

[Examples of Use of the Communication System]

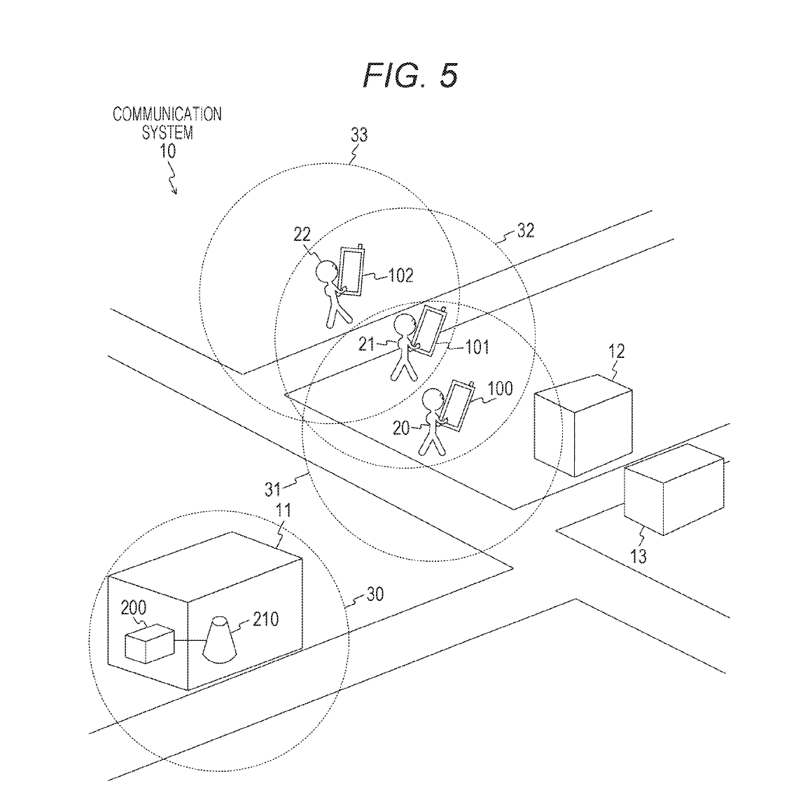

FIGS. 4 and 5 are diagrams showing examples of use of the communication system 10 according to the embodiment of the present technology.

In FIGS. 4 and 5, shops 11 through 13 existing in a commercial facility (such as a large shopping mall ABC), and users (who are doing shopping in the commercial facility) 20 through 22 are shown, for example. The users 20 through 22 carry and use the information processing devices 100 through 102, respectively. The information providing server 200 and the access point 210 are installed in the shop 11.

The range in which the access point 210 can perform direction communication using wireless communication (the range is the information transmittable range having the access point 210 at the reference position) is shown as an information transmittable range 30.

The range in which the information processing device 100 can perform direction communication using wireless communication (the range is the information transmittable range having the information processing device 100 at the reference position) is shown as an information transmittable range 31. Likewise, the range in which the information processing device 101 can perform direction communication using wireless communication (the range is the information transmittable range having the information processing device 101 at the reference position) is shown as an information transmittable range 32. Likewise, the range in which the information processing device 102 can perform direction communication using wireless communication (the range is the information transmittable range having the information processing device 102 at the reference position) is shown as an information transmittable range 33.

In the example shown in FIG. 4, the information processing device 100 exists in the information transmittable range 30, but the information processing devices 101 and 102 do not exist in the information transmittable range 30. The information processing device 100 does not exist in the information transmittable ranges 32 and 32. The information processing device 101 exists in the information transmittable range 33, and the information processing device 102 exists in the information transmittable range 32.

FIG. 5 shows a state observed after the users 20 through 22 have moved from the state shown in FIG. 4. In the example shown in FIG. 5, the information processing device 100 exists in the information transmittable range 32, but does not exist in the information transmittable range 33. The information processing device 101 exists in the information transmittable ranges 31 and 33. The information processing device 102 exists in the information transmittable range 32, but does not exist in the information transmittable range 31.

These days, there are many people carrying around information processing devices (highly-sophisticated terminals) such as smartphones and tablet terminals. Therefore, people are likely to use such information processing devices for obtaining information while doing shopping. For a customer who has entered the premises of a shop, for example, information about the shop might be transmitted to an information processing device (such as a smartphone or a tablet terminal) being carried by the customer through wireless communication (a wireless LAN, for example). The information about the shop to be transmitted may include advertising information for notifying the customer what kind of product is being sold at which part of the shop, information for notifying the customer which products are selling well, and coupons for discounts at the shop, for example.

Such transmission of information about a shop to customers of the shop benefits both the shop and the customers. As the shop can readily and promptly transmit the information about the shop to customers, it is possible to efficiently provide the customers with the information about the shop. As the customers can readily obtain the information about the shop, the customers can make effective use of the information in shopping at the shop.

In the case of a facility such as a large shopping mall with a large number of shops, it is critical to efficiently provide a large number of users of the facility with information about the respective shops.

In the example shown in FIG. 4, information about the shop 11 (shop information) can be provided to the user 20 existing in the information transmittable range 30 of the access point 210, for example. That is, the information providing server 200 installed in the shop 11 can transmit the shop information (content) about the shop 11 to the information processing device 100 existing in the information transmittable range 30 via the access point 210. The information processing device 100 that has received the shop information about the shop 11 can display the shop information about the shop 11 on the display unit 142. An example of this display is shown in FIG. 6.

[Example of Display of Shop Information]

FIG. 6 is a diagram showing an example of display of shop information (the shop information display screen 500) displayed on the display unit 142 according to the embodiment of the present technology.

The shop information display screen 500 is a display screen that displays content (the shop information about the shop 11) acquired from the access point 210 connected thereto through wireless communication. The shop information display screen 500 also displays information based on the content (shop information about the shop 11) provided from the information providing server 200.

For example, a shop information display area 501, an other-shop-information button 502, and an exit button 503 are displayed on the shop information display screen 500.

In the shop information display area 501, a coupon display area 504 and a shop location display area 505 are displayed together with the shop information about the shop 11 (various messages, for example).

The shop information display area 501 is an area that displays various kinds of information about the shop. For example, a message advertising that the shop is offering discounts is currently displayed.

The coupon display area 504 is an area that displays a coupon being offered by the shop 11.

The shop location display area 505 is an area that displays display information for specifying the location of the shop 11 having its shop information being displayed in the shop information display area 501. For example, a map showing the locations of the shop 11 and the information processing device 100 is displayed in the shop location display area 505. On this map, an icon 506 indicating the location of the shop 11 and an icon 507 indicating the location of the information processing device 100 are also displayed. The icon 507 is displayed based on the location information acquired by the location information acquiring unit 115.

The other-shop-information button 502 is the button to be pressed to display shop information other than the shop information displayed in the shop information display area 501 and the shop location display area 505. The other-shop-information button 502 is displayed only if other shop information is recorded in the memory 130.

The exit button 503 is the button to be pressed when the shop information display is ended.

As the shop information about the shop 11 is provided to the user 20, the interest of the user 20 in the shop 11 can be increased, and the user 20 can be attracted to the shop 11.

Although a coupon and a map are displayed as the shop information in the example shown in FIG. 6, some other information may be displayed as the shop information. For example, it is possible to display a list of the products available at the shop, the layout of the products (an in-store map), product information such as bargain information, coupons, the number of acquired points, and the likes.

Although the shop information about one shop is displayed in the example shown in FIG. 6, it is possible to simultaneously display shop information about more than one shop.

Referring back to FIG. 4, the user 20 might be a user who is interested in and approach the shop 11, or might be a user who happens to pass by. In such a case where the shop information about the shop 11 is provided only to the user 20 existing in the information transmittable range 30 of the access point 210, the shop information about the shop 11 is provided only to users who are interested in and approach the shop 11. That is, there is a possibility that the shop information about the shop 11 cannot be appropriately provided to other users (such as the users 21 and 22).

For example, the users 21 and 22 who do not exist in the information transmittable range 30 of the access point 210 might be interested in the shop 11. The user 21 and 22 might not know of the existence of the shop 11, though being interested in the products (hats) being sold at the shop 11, for example. In such a case, it is critical to prevent loss of opportunities on both sides by appropriately providing the users 21 and 22 with the shop information about the shop 11. That is, providing the shop information about the shop 11 only to the user existing in the vicinity of the shop 11 is insufficient, and, in view of sales promotion, it is important to provide the shop information about the shop 11 to users far away from the shop 11 (potential customers).

Therefore, there is a proposed method for providing the shop information about the shop 11 to other information processing devices (such as the information processing devices 101 and 102) using multihop relay. By this method, the range in which the shop information about the shop 11 is transmitted can be expanded with the multihop relay, and information about the information transmission path can be acquired.

In a case where information transmission is conducted with multihop relay, however, the information transmittable range is limited to the range in which the multihop relay is possible (that is, other information processing devices need to be exist in the radio wave reachable range). Also, in a case where information transmission is conducted with multihop relay, the information can be transmitted to only the information processing devices that exist in the multihop relay range at the time when the information is transmitted from the transmission source (such as the information providing server 200 or the access point 210). That is, the information cannot be transmitted to the information processing devices that do not exist in the multihop relay range at the time when the information is transmitted from the transmission source.

In the example shown in FIG. 4, the information processing device 100 exists neither in the information transmittable range 32 of the information processing device 101 nor in the information transmittable range 33 of the information processing device 102. Therefore, even if transmission of the shop information (content) about the shop 11 transmitted from the information providing server 200 installed in the shop 11 to the information processing device 100 is tried to be transmitted with multihop relay, the shop information about the shop 11 cannot be transmitted to either of the information processing devices 101 and 102.

In this manner, information transmission with multihop relay is subjected to distance restrictions and time restrictions.

In view of this, there is a proposed method for spreading information in a store-and-forward manner. By this method, information is temporarily stored in an information processing device existing in the information transmittable range of the transmission source, and the information is then spread to other information processing devices. In this manner, the distance restrictions and the time restrictions on multihop relay can be eliminated.

Here, the time to transmit the current transmission content in accordance with the environment in which the communication system 10 is used is important. An example case where the user 20 has exited the shopping mall ABC shown in FIG. 4, and moved to a place far away from the shopping mall ABC (a place at a distance of 100 km or longer from the shopping mall ABC, for example) is now described. In such a case, even if the shop information about the shop 11 is transmitted from a place far away from the shopping mall ABC, the users who receive the shop information about the shop 11 might not be very interested in the shop 11. That is, it is critical to appropriately determine by when the current transmission content should be transmitted, how the current transmission content should be transmitted, and how the current transmission content should be relayed, and transmit the current transmission content at an appropriate time.

In view of this, according to the embodiment of the present technology, content (such as shop information) is spread in a store-and-forward manner using a relay node, and the content spreading range is restricted in accordance with the place, the time, and the number of times relay is performed. In this manner, content can be appropriately provided to a target node (an information processing device) in a place such as a shopping mall.

In the example shown in FIG. 4, the information providing server 200 can transmit content directly to the information processing device 100 existing in the information transmittable range 30 of the access point 210. However, the information providing server 200 cannot transmit content directly to the information processing devices 101 and 102 not existing in the information transmittable range 30 of the access point 210. Therefore, the information processing device 100 records the content received from the information providing server 200 into the memory 130 (shown in FIG. 2). When the user 20 moves into the information transmittable range 32 of the information processing device 101, as shown in FIG. 5, the content recorded in the memory 130 can be transmitted to the information processing device 101, for example.

That is, the user 20 (the information processing device 100) having received content from the access point 210 installed in the shop 11 can serve as an information transmission source. The information processing device 100 can transfer the content received from the access point 210 to other users (potential customers (the users 21 and 22) (the information processing devices 101 and 102)), using ad-hoc communication of a wireless LAN.

As the user 20 does not stay in one place but moves around, the information providing range can be expanded in the above manner. That is, as the user 20 walks around in the shopping mall ABC, the information transmission distance can be made longer.

Also, exchange of content between those information processing devices is realized by ad-hoc communication.

[Example Format of Information]

FIG. 7 is a diagram schematically showing an example format of information 300 to be communicated between the respective devices constituting the communication system 10 according to the embodiment of the present technology.

The information 300 to be communicated between the respective devices includes a source terminal ID 301, a destination terminal ID 302, an information element identifier 303, and data 304.

The source terminal ID 301 is the identification information (Identification Number) for identifying the information transfer source (an information processing device). The destination terminal ID 302 is the identification information for identifying the information transmission destination (an information processing device). These pieces of identification information may be IDs unique to the respective devices (such as MAC (Media Access Control) addresses).

The information element identifier 303 is the information for identifying what the current transmission information is. For example, the information for identifying an advertisement 310, an information transfer request 311, or a user information transfer 312 is stored in the information element identifier 303.

The advertisement 310 is the information indicating that the contents of the data 304 are an advertisement. Here, the advertisement is the information for notifying nearby people of its existence, and is to be transmitted to a large unspecified number of users by broadcasting. An example format in a case where the advertisement 310 is stored in the information element identifier 303 is shown in a in FIG. 8.

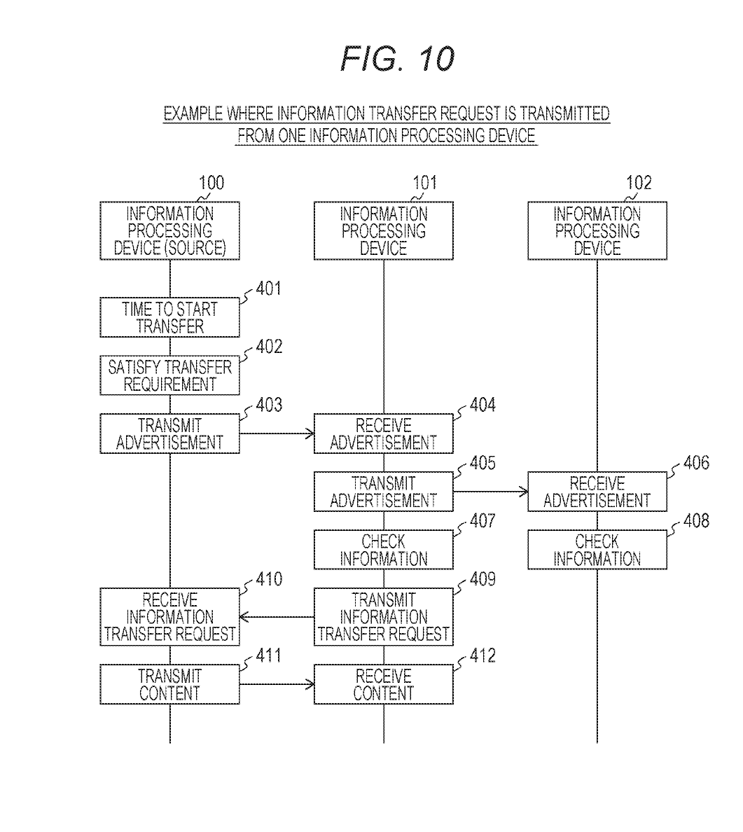

The information transfer request 311 is the information indicating that the contents of the data 304 are an information transfer request. That is, in a case where the information transfer request 311 is stored in the information element identifier 303, information about an information transfer request is stored in the data 304. For example, an information transfer request is transmitted in the procedures (409 and 410) shown in FIG. 10.

The user information transfer 312 is the information indicating that the contents of the data 304 are user information transfer. An example format in a case where the user information transfer 312 is stored in the information element identifier 303 is shown in b in FIG. 8.

The data 304 is the data corresponding to the information stored in the information element identifier 303.

As described above, information of any of the three kinds of information, which are an advertisement, an information transfer request, and user information transfer, can be transmitted in the above format of the information 300. These kinds of information are distinguished from one another by the information element identifier 303.

[Example Format of the Advertisement]

FIG. 8 is a diagram schematically showing an example format of information to be communicated between the respective devices constituting the communication system 10 according to the embodiment of the present technology.

An example format of an advertisement 320 is shown in a in FIG. 8.

The advertisement 320 includes a source terminal ID 321, a broadcast 322, an advertisement 323, and an information ID 324. The source terminal ID 321 is equivalent to the source terminal ID 301 shown in FIG. 7, and the broadcast 322 is equivalent to the destination terminal ID 302 shown in FIG. 7. The advertisement 323 is equivalent to the information element identifier 303 shown in FIG. 7, and the information ID 324 is equivalent to the data 304 shown in FIG. 7.

As described above, an advertisement is transmitted by broadcasting for transmitting data to a large unspecified number of users. Therefore, the broadcast 322 indicating a large unspecified number of transmission destinations, instead of the identification information about a certain transmission destination (an information processing device), is stored in the destination terminal ID 302.

The information ID 324 is the unique information for identifying the current transmission content. Here, in a case where the content corresponding to an advertisement is content already stored in the memory, the information processing device on the receiving side does not need to newly receive the content corresponding to the advertisement. To avoid unnecessary information transfer, it is necessary to determine whether the information corresponding to the advertisement is content already received and stored in the memory, or whether the information corresponding to the advertisement is newly-received content. In making this determination, the information ID 324 is used.

The information ID 324 may be in any format, as long as it is unique information for identifying the current transmission content. For example, the information ID 324 may be in the form of a shop ID 325 or a content ID 326. The shop ID 325 is unique information for identifying each shop, and the content ID 326 is unique information for identifying content.

An example format of a user information transfer 330 is shown in b in FIG. 8. The user information transfer 330 is the format to be used in a case where information is transferred.

The user information transfer 330 includes a source terminal ID 331, a destination terminal ID 332, a user information transfer 333, information transfer histories [0] 334 through [n] 336, an information ID 337, and content 338. The source terminal ID 331 is equivalent to the source terminal ID 301 shown in FIG. 7, and the destination terminal ID 332 is equivalent to the destination terminal ID 302 shown in FIG. 7. The user information transfer 333 is equivalent to the information element identifier 303 shown in FIG. 7, and the information transfer histories [0] 334 through [n] 336, the information ID 337, and the content 338 are equivalent to the data 304 shown in FIG. 7.

Here, the current transmission information (content) might be transferred via more than one information processing device. Therefore, to control information transfer, it is necessary to record histories indicating how the information has been transferred. In view of this, the information transfer histories [0] 334 through [n] 336 are recorded in the user information transfer 330.

Here, [n] of each information transfer history (n being an integer of 0 or greater indicating the number of times transfer has been performed) is the number indicating the history at the time when content transfer is repeated. Also, [0] of each information transfer history means the information transmission source (the access point 210 (the information providing server 200) shown in FIG. 4, for example) that has first output content. In this manner, the information transfer histories [0] 334 through [n] 336 are recorded, as information transfer histories are sequentially added in accordance with the number of times transfer has been performed.

Each information transfer history [n] (n being an integer of 0 or greater indicating the number of times transfer has been performed) includes an information transmission source ID 341, an information transmission time 342, and an information transmission source location 343.

The information transmission source ID 341 is the unique information for identifying the information processing device of the information transmission source. For example, the unique information for identifying the information processing device (the access point 210, for example) that has first transmitted content is stored in the information transmission source ID [0] 341. Also, the unique information for identifying the information processing device (the information processing device 100, for example) that has transmitted content next is stored in the information transmission source ID [1] 341, for example.

The information transmission time 342 is the time information for identifying the time at which the user information transfer 330 has been transmitted. For example, the time information (the current time) acquired by the clock 180 at the time when the user information transfer 330 has been transmitted is stored in the information transmission time 342. For example, the time information for identifying the time when content has been first transmitted (a time of transmission from the access point 210, for example) is stored in the information transmission time [0] 342. Also, the time information for identifying the time when content has been transmitted next (a time of transmission from the information processing device 100, for example) is stored in the information transmission time [1] 342, for example.

The information transmission source location 343 is the location information for identifying the location at which the user information transfer 330 has been transmitted. For example, the location information (the current location) acquired by the location information acquiring unit 115 at the time when the user information transfer 330 has been transmitted is stored in the information transmission source location 343. For example, the location information (the location information acquired by the location information acquiring unit 220 shown in FIG. 3, for example) for identifying the location at which content has been first transmitted (the location at which the access point 210 is installed, for example) is stored in the information transmission source location [0] 343. Also, the location information for identifying the location at which content has been transmitted next (the location at which the information processing device 100 exists, for example) is stored in the information transmission source location [1] 343, for example.

The information ID 337 is equivalent to the information ID 324 shown in a in FIG. 8. Likewise, a shop ID 345 is equivalent to the shop ID 325 shown in a in FIG. 8, and a content ID 346 is equivalent to the content ID 326 shown in a in FIG. 8.

The content 338 is the data of the current transfer content. For example, in a case where the current transfer content is the shop information about the shop 11, the data (content) for displaying the shop information display screen 500 shown in FIG. 6 is stored in the content 338.

In this manner, the information transfer histories [0] 334 through [n] 336 and the information ID 337 can be obtained as the information accompanying the content 338. Using this information accompanying the content, the control unit 120 of the information processing device 100 can perform various kinds of control. For example, the control unit 120 can perform control to add a benefit to the content based on the information accompanying the content. The benefit can be increased in accordance with the number of times transfer has been performed, for example. In a case where the number of times transfer has been performed is equal to or greater than a threshold value A, for example, the discount specified in the coupon is increased by 5%. In a case where the number of times transfer has been performed is equal to or greater than a threshold value B (B>A), the discount specified in the coupon is increased by 7% Also, the control unit 120 may count the number of times content recorded in the memory 130 has been transferred to other information processing devices, for example, and add a bonus to the content based on the number of times transfer has been performed (the number of times the same content has been transferred).

Here, the history information (the information transmission source ID 341) associated with content received from another information processing device might include history information (the information transmission source ID 341) connected to the information processing device 100, for example. Also, content transferred by the information processing device 100 might be transferred back to the information processing device 100 via one or more other information processing devices, for example. In this case, the control unit 120 may discard (delete) the content from the memory 130. As described above, in a case where content transferred by a device is transferred back to the device, the content is discarded so that content congestion can be avoided.

[Examples of Times for Content Transfer]

As described above, an information processing device that has transmitted content (shop information, for example) can transfer (redistribute) the received content to another information processing device. Here, an example case where an information processing device that has received content transfers the received content to another information processing device immediately after the reception, or where the information processing device continues the transfer of the received content to another information processing device is described. In such a case, wireless network congestion might occur due to content transfer. Also, the meaning of transfer might be diluted due to unlimited information transfer. Therefore, it is critical to restrict content transfer, so as to avoid wireless network congestion due to content transfer and avoid dilution of the meaning of transfer due to unlimited information transfer.

Therefore, content transfer is performed at an appropriate time in the embodiment of the present technology. Examples of determination of a time to transfer content will be described below.

First, an example of determination of a time to start content transfer (a transfer start time) is described.

[Example of Determination of a Transfer Start Time Based on the Distance (Linear Distance) from the Transmission Source]

A transfer start time can be determined based on the distance from the transmission source, for example. Specifically, the distance (linear distance) between the transmission source (the access point 210 shown in FIG. 4, for example) and the information processing device 100 is calculated, and, if the distance is greater than a threshold value serving as the reference value, the current time can be determined to be a transfer start time. In this case, the location information (the latitude and the longitude) about the transmission source is recorded in the information transmission source location [0] 343 shown in b in FIG. 8. Also, the location information (the latitude and the longitude) about the information processing device 100 is acquired by the location information acquiring unit 115. The control unit 120 of the information processing device 100 then calculates the distance between the transmission source and the information processing device 100 based on the location information (the latitude and the longitude) about the transmission source and the location information about the information processing device 100.

Here, the threshold value can be set in accordance with environments, for example. For example, in the case of a commercial facility in which users walk around as shown in FIG. 4, a value between 100 meters and 150 meters can be set as the threshold value.

In a case where the distance is greater than the threshold value serving as the reference value, the distance may be not smaller than the threshold value, or may be greater than the threshold value. In a case where the distance is smaller than the threshold value serving as the reference value, the distance may be not greater than the threshold value, or may be smaller than the threshold value. In a case where being greater than the threshold value serving as the reference value means being not smaller than the threshold value, being smaller than the threshold value serving as the reference value means being smaller than the threshold value. In a case where being greater than the threshold value serving as the reference value means being greater than the threshold value, being smaller than the threshold value serving as the reference value means being not greater than the threshold value.

[Example of Determination of a Transfer Start Time Based on a Movement Distance from the Transmission Source]

An example case where a transfer start time is determined based on the linear distance from the transmission source has been described above. Here, if the street is winding, for example, the linear distance is short, but the movement distance might be long. In such a case, it is preferable to determine a transfer start time based on the movement distance from the transmission source, rather than the linear distance from the transmission source.

In this example, a transfer start time is determined based on the movement distance from the transmission source. Specifically, the location information acquiring unit 115 regularly or irregularly acquires the location information (the latitude and the longitude) about the information processing device 100. The control unit 120 of the information processing device 100 then calculates the distance from the location where the location information is acquired to the location where location information was acquired last time based on the acquired location information and the location information acquired last time. That is, the distances between acquisitions of location information are sequentially calculated. The control unit 120 of the information processing device 100 then adds up the calculated distances, to calculate the movement distance between the transmission source and the information processing device 100. Alternatively, the distance between the transmission source and the information processing device 100 may be calculated with a sensor (an acceleration sensor or a gyro sensor, for example). In a case where the location information acquiring unit 115 is a GPS receiver, the movement distance between the transmission source and the information processing device 100 may be calculated from a movement locus acquired with a GPS signal.

Here, the threshold value can be set in accordance with environments, for example. For example, in the case of a commercial facility in which users walk around as shown in FIG. 4, a value between 200 meters and 400 meters can be set as the threshold value.

[Example of Determination of a Transfer Start Time Based on the Time Since the First Content Reception]

Example cases where a transfer start time is determined based on the distance (the linear distance or the movement distance) from the transmission source have been described above. In the example described below, a transfer start time is determined based on the time that has elapsed since content reception. First, an example case where a transfer start time is determined based on the time that has elapsed since the first content reception is described.

Specifically, the time that has elapsed since the time when the information processing device 100 first received content from the transmission source (the access point 210 shown in FIG. 4, for example) is calculated, and, if the elapsed time is greater than a threshold value serving as the reference value, the current time can be determined to be a transfer start time. In this case, the time when the information processing device 100 first received content (the first content reception time) is recorded in the information transmission time [0] 342 shown in b in FIG. 8. The current time is acquired by the clock 180. Based on the first content reception time and the current time, the control unit 120 of the information processing device 100 calculates the time that has elapsed since the time when the information processing device 100 first received content from the transmission source.

Here, the threshold value can be set in accordance with environments, for example. For example, in the case of a commercial facility in which users walk around as shown in FIG. 4, a value between 10 minutes and 20 minutes can be set as the threshold value.

[Example of Determination of a Transfer Start Time Based on the Time Since the Last Information Transmission]

Next, an example case where a transfer start time is determined based on the time that has elapsed since the last content reception is described.

Specifically, the time that has elapsed since the time when the information processing device 100 last transferred content received from the transmission source (the access point 210 shown in FIG. 4, for example) is calculated. If the calculated elapsed time is greater than a threshold value serving as the reference value, the information processing device 100 can determine that it is time to start transfer. In this case, the time when the information processing device 100 last transferred information (the last information transfer time) is recorded in the item last recorded among the information transmission times [0] through [n] 342 shown in b in FIG. 8. The current time is acquired by the clock 180. Based on the last content reception time and the current time, the control unit 120 of the information processing device 100 calculates the time that has elapsed since the time when the information processing device 100 last transferred information.

Here, the threshold value can be set in accordance with environments, for example. For example, in the case of a commercial facility in which users walk around as shown in FIG. 4, a value between five minutes and 10 minutes can be set as the threshold value. The threshold value may be changed with time. For example, the threshold value can be made smaller with time.

[Example Case where a Transfer Start Time Comes at Regular Time Intervals]

Next, an example case where a transfer start time comes at regular time intervals is described.

Specifically, every time a certain period of time (10 minutes, for example) has passed, the current time is determined to be the time to start transferring content received by the information processing device 100 from the transmission source (the access point 210 shown in FIG. 4, for example).

[Example of Determination of a Transfer Start Time Based on a Combination of Different Pieces of Information]

In the examples described above, a transfer start time is determined based on information (the distance or the time) accompanying content. Here, a transfer start time may be determined based on a single piece of information (the distance or the time), or may be determined based on a combination of different pieces of information (the distance and the time).

For example, a transfer start time may be determined by combining the example of determination of a transfer start time based on the movement distance from the transmission source and the example of determination of a transfer start time at regular time intervals. In this case, the current time is determined to be a transfer start time when the movement distance from the transmission source becomes greater than a threshold value serving as the reference value, and thereafter, the current time can be determined to be a transfer start time every time a certain period of time passes, for example. After the movement distance from the transmission source exceeds 100 meters, for example, the current time can be determined to be a transfer start time every 10 minutes. Alternatively, it is possible to use some other combination in the determination. For example, when at least one of the pieces of information (the distance and the time) accompanying content is greater than a threshold value serving as the reference value, the current time can be determined to be a transfer start time.

[Examples of Determination as to Whether to Allow Content Transfer]

In the examples described above, a time to start transferring information is determined. If the current transfer content is old (one or more days old, for example), the location of acquisition of the current transfer content might be at a long distance (at a distance of 100 km or longer from the transmission source, for example). In such a case, even if the current time is determined to be a time to start transferring content, the meaning of transferring the content might have been diluted. Therefore, in such a case, even if the current time is determined to be a time to start transferring content, transfer of the content is preferably restricted. In view of this, examples of determination as to whether to allow actual transfer of content after it is determined to be time to start transferring the content will be described below (examples of determination of transfer restriction).

[Example of Determination of Transfer Restriction Based on the Number of Times Transfer has been Performed]

For example, if the number of times transfer has been performed is greater than a threshold value serving as the reference value, further transfer can be prohibited. The number of times transfer has been performed is the number of the information transfer histories [0] 334 through [n] 336 shown in b in FIG. 8. Also, the threshold value can be set in accordance with environments, for example. For example, a value between 10 and 20 can be set as the threshold value.

[Example of Determination of Transfer Restriction Based on the Distance (Linear Distance) from the Transmission Source]

For example, a case where the user 20 has moved out of the premises of the shopping mall ABC in the example shown in FIG. 4 is described. In this case, the user 20 might have moved far away from the shop 11. Therefore, even if the shop information (such as shop information and coupons) about the shop 11 is distributed to the other information processing devices, chances might be low that the distribution of the information will lead to actual purchasing behavior.

In view of this, if the linear distance from the transmission source is greater than a threshold value serving as the reference value, further transfer is prohibited. As a result, unnecessary transfer can be restrained. Here, the method of calculating the linear distance is the same as the calculation method described in the example of determination of a transfer start timing. The threshold value to be used in determining transfer restriction is a greater value than the threshold value to be used in determining a transfer start time. The threshold value to be used in determining transfer restriction can be between 20 km and 100 km, for example.

[Example of Determination of Transfer Restriction Based on the Time Since the First Content Reception]

Freshness is the essence of information, and old information is often of no value. In a case where the shop information about the shop 11 is a discount coupon that is valid only one day, for example, the shop information is valuable only on the one day. In view of this, transfer restriction may be determined based on the time that has elapsed since the first content reception.

Specifically, the time that has elapsed since the time when the information processing device 100 first received content from the transmission source (the access point 210 shown in FIG. 4, for example) is calculated, and, if the elapsed time is greater than a threshold value serving as the reference value, it is possible to determine that transfer should be determined. Here, the method of calculating the elapsed time is the same as the calculation method described in the example of determination of a transfer start timing. The threshold value to be used in determining transfer restriction is a greater value than the threshold value to be used in determining a transfer start time. The threshold value to be used in determining transfer restriction may be half a day (12 hours) or one day (24 hours), for example.

[Example of Determination of Transfer Restriction Based on a Combination of Different Pieces of Information]

In the examples described above, transfer restriction is determined based on information accompanying content (the accompanying information being the number of times transfer has been performed, the distance, or the time). Here, transfer restriction may be determined based on a single piece of information (the number of times transfer has been performed, the distance, or the time), or may be determined based on a combination of different pieces of information (the number of times transfer has been performed, the distance, and the time). When at least one of the pieces of information is greater than a threshold value serving as the reference value, for example, it is possible to determine that transfer should be restricted. That is, if one of the transfer requirements is satisfied, it is possible to determine that transfer should be restricted. Alternatively, it is possible to use some other combination in the determination.

The content restricted from being transferred is not to be transferred thereafter. Therefore, the content restricted from being transferred is preferably deleted from the memory 130.

In this manner, transfer restriction is determined based on the information accompanying content (the accompanying information being the number of times transfer has been performed, the distance, and the time), so that unnecessary transfer of the content can be restrained.

[Example of Determination Based on Altitude]

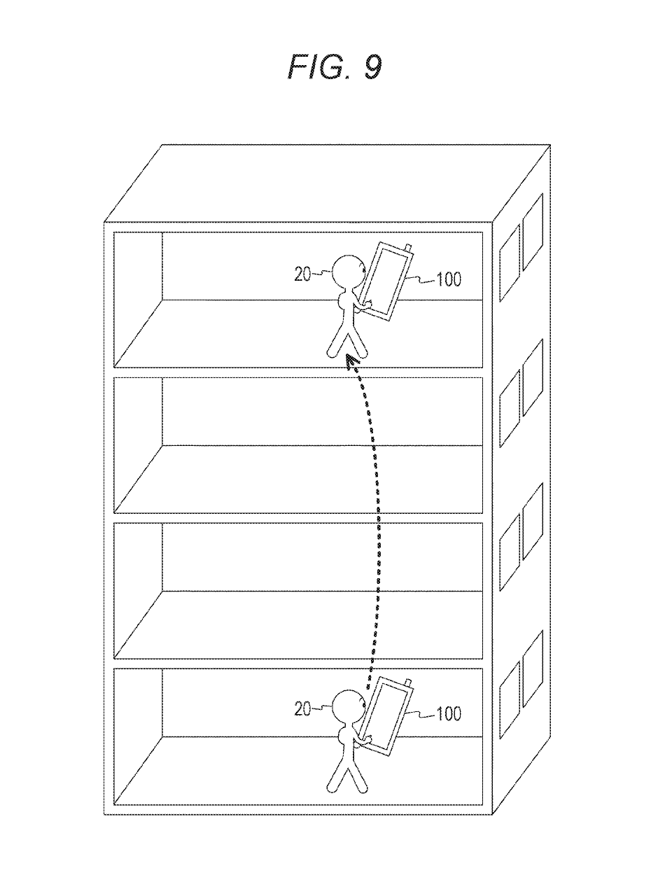

FIG. 9 is a diagram showing an example of movement in a case where the user 20 carrying the information processing device 100 moves around in a building according to the embodiment of the present technology.

In the examples described above, a transfer start time or transfer restriction is determined based on a distance in a plane. As shown in FIG. 9, however, the user 20 carrying the information processing device 100 might move around in a building. In such a case, the respective kinds of determination may be made based on altitude.

In a building such a shopping mall or a department store, latitude and longitude might remain substantially the same, but altitude might vary. In the four-story building shown in FIG. 9, for example, the user 20 carrying the information processing device 100 might move from the first floor to the fourth floor. In this case, even if the latitude and the longitude remain substantially the same, the current time can be determined to be a transfer start time. Alternatively, when the user moves to another floor (from the second floor to the third floor, for example), the current time can be determined to be a transfer start time. That is, when the altitude changes by an amount equal to or greater than a threshold value, the current time can be determined to be a transfer start time.

If the location information acquiring unit 115 is a GPS receiver, the altitude of the information processing device 100 can be acquired based on a GPS signal. Alternatively, the altitude (or the movement distance in the vertical direction) of the information processing device 100 may be acquired with a sensor (such as a gyro sensor, an acceleration sensor, an atmospheric pressure sensor, or a pressure sensor).

[Examples of Setting of the Respective Threshold Values]

In the examples described above, a transfer start time or transfer restriction is determined with the use of the respective threshold values. These threshold values may be set in each information processing device, or may be set by a content provider (a shop or a shopping mall, for example). In a case where the respective threshold values are set in information processing devices, each threshold value may be set as a fixed value, or each threshold value can be changed by a user operation. Alternatively, each threshold value may be changed depending on the means of transportation. For example, a threshold value in the case of walking can be different from a threshold value in the case of moving on a vehicle. In this case, the threshold value in the case of walking can be larger than the threshold value in the case of moving on a vehicle, for example. The means of transportation can be determined based on the movement distance per unit time, for example.

In a case where a content provider sets the respective threshold values, the respective threshold values are associated with content, so that the respective threshold values can be set in each information processing device. For example, an information processing device that has received the content can determine a transfer start time and transfer restriction with respect to the content, using the respective threshold values associated with the content.

Also, in a case where a content provider sets the respective threshold values, the respective threshold values are provided to the information processing devices in a predetermined range through wireless communication, so that the respective threshold values can be set in the respective information processing devices. For example, the respective threshold values are transmitted to information processing devices entering the premises of the shopping mall ABC shown in FIG. 4, through wireless communication (such as non-contact wireless communication or a wireless LAN). The information processing devices that have received the respective threshold values automatically set the received threshold values therein. In this manner, common threshold values can be set with respect to all the shops in the shopping mall ABC, for example. Alternatively, different threshold values from one shop to another (from one piece of content to another) may be provided and set.

As a content provider manages the respective threshold values in the above manner, providing of content, setting of a time for spreading content, setting of a content spreading range, exhaustion of content can be managed on the content provider side. Therefore, there is no need to construct a special information providing network. Accordingly, the communication system according to the embodiment of the present technology can be readily utilized.

As described above, after reception of content, the control unit 120 of the information processing device 100 performs control to transfer the content to another information processing device existing in a predetermined range on the basis of the location of the information processing device 100. In this case, the control unit 120 determines whether the current time satisfies a predetermined condition based on the information accompanying the received content (the accompanying information being the transmission location, the transmission time, the number of times transfer has been performed, or the like). For example, the control unit 120 determines whether the current location is a location (a location at which the current time is determined to be a transfer start time, for example) that satisfies a predetermined condition based on the location of the first content transmission (the location of the access point 210 shown in FIG. 4, for example). The control unit 120 also determines whether the current location is a location that does not satisfy the predetermined condition (a location at which transfer is determined to be restricted, for example). After the time when the predetermined condition is satisfied for the first time, the control unit 120 transfers content to another information processing device until the time when the predetermined condition fails to be satisfied. Also, if the current time is determined not to satisfy the predetermined condition, the control unit 120 may discard (deletes) the content from the memory 130.

[Example of Communication]

FIG. 10 is a sequence chart showing an example of a communication process between the respective devices constituting the communication system 10 according to the embodiment of the present technology.

In the example of the communication process shown FIG. 10, content received from the information providing server 200 via the access point 210 is recorded in the memory 130 of the information processing device 100. Also, in the example of the communication process shown in FIG. 10, content recorded in the memory 130 of the information processing device 100 has already been acquired by the information processing device 102, but has not been acquired by the information processing device 101. In the example of the communication process shown in FIG. 10, the information processing device 101 exists in the information transmittable range 31 of the information processing device 100, but the information processing device 102 does not exist in the information transmittable range 31 of the information processing device 100, as shown in FIG. 5. Also, the information processing device 102 exists in the information transmittable range 32 of the information processing device 101.

The content recorded in the memory 130 of the information processing device 100 is the shop information about the shop 11 shown in FIG. 4, and is the content for displaying the shop information display screen 500 shown in FIG. 6, for example. The shop ID of the shop 11 is “HAT01”, and the content ID is “101”.

First, the control unit 120 of the information processing device 100 determines whether there is content that has reached a transfer start time among the pieces of content recorded in the memory 130 (401). If no content has reached the transfer start time (401), monitoring is continued. This transfer start time can be determined according to any of the above described examples of determination.

If there is content that has reached the transfer start time (401), the control unit 120 of the information processing device 100 determines whether the content that has reached the transfer start time satisfies a transfer requirement (402). That is, a check can be made to determine whether a transfer requirement is satisfied based on whether the content that has reached the transfer start time is restricted from being transferred as described above. If the content that has reached the transfer start time is restricted from being transferred as described above, the content is determined not to satisfy the transfer requirement, for example. If the content that has reached the transfer start time is not restricted from being transferred as described above, on the other hand, the content is determined to satisfy the transfer requirement.

If the content that has reached the transfer start time satisfies the transfer requirement (402), the control unit 120 of the information processing device 100 transmits an advertisement in a broadcast-like manner (403 and 404). In this case, the advertisement is transmitted in a broadcast-like manner in accordance with an advertisement format (the advertisement 320 shown in a in FIG. 8) (403 and 404). The identification information about the information processing device 100 is stored in the source terminal ID 321 (shown in a in FIG. 8) included in the advertisement 320 in this case, and information indicating simultaneous transmission is stored in the broadcast 322 (shown in a in FIG. 8). The advertisement 323 is stored in the information element identifier 303 (shown in FIG. 7), and the information ID 324 is stored in the data 304 (shown in FIG. 7). The above mentioned “HAT01” is stored in the shop ID 325 included in the information ID 324, and the above mentioned “101” is stored in the content ID 326.

In this manner, in accordance with the advertisement format, the information ID 324 about content held in the information processing device 100 is sent to the information processing device 101 existing in the vicinity of the information processing device 100 (403 and 404).

The control unit of the information processing device 101 that has received the advertisement 320 transmits the advertisement 320 in a broadcast-like manner (405 and 406). The identification information about the information processing device 101 is stored in the source terminal ID 321 (shown in a in FIG. 8) included in the advertisement 320 in this case. The other pieces of the information are the same as those of the advertisement transmitted from the information processing device 100.

The control unit of the information processing device 101 that has received the advertisement 320 also checks whether the information processing device 101 has acquired the content corresponding to the advertisement 320 (407). Likewise, the control unit of the information processing device 102 that has received the advertisement 320 checks whether the information processing device 102 has acquired the content corresponding to the advertisement 320 (408). In this case, a check is made to determine whether the content corresponding to the information ID 324 included in the advertisement 320 is stored in the memory (407 and 408).

As described above, the information processing device 101 has not acquired the content corresponding to the advertisement 320 (content recorded in the memory 130 of the information processing device 100). Therefore, the control unit of the information processing device 101 transmits an information transfer request to the transmission source (the information processing device 100) of the advertisement 320 (409 and 410). The identification information about the information processing device 100 is stored in the source terminal ID 321 (shown in FIG. 7) included in the current transmission information in this case, and the identification information about the information processing device 101 is stored in the destination terminal ID 302 (shown in FIG. 7). The information transfer request 311 is stored in the information element identifier 303 (shown in FIG. 7), and information about the information transfer request is stored in the data 304 (shown in FIG. 7).

The control unit 120 of the information processing device 100 that has received the information transfer request transmits the content corresponding to the broadcast-transmitted advertisement 320 to the information processing device (the information processing device 101) that has transmitted the information transfer request (411 and 412).

The identification information about the information processing device 100 is stored in the source terminal ID 331 (shown in a in FIG. 8) included in the current transmission information (user information transfer) in this case, and the identification information about the information processing device 101 is stored in the destination terminal ID 332 (shown in a in FIG. 8). The user information transfer 333 (shown in a in FIG. 8) is stored in the information element identifier 303 (shown in FIG. 7).

Information about the time of the transmission from the access point 210 to the information processing device 100 is stored in the respective portions (the information transmission source ID [0] 341, the information transmission time [0] 342, and the information transmission source location [0] 343) of the information transfer history [0] 334 (shown in b in FIG. 8). Also, information about the time of the transmission from the information processing device 100 to the information processing device 101 is stored in the respective portions (the information transmission source ID [1] 341, the information transmission time [1] 342, and the information transmission source location [1] 343) of the information transfer history [1] 335 (shown in b in FIG. 8). That is, information about the current transmission is stored in the respective portions of the information transfer history [1] 335.

The above mentioned “HAT01” is stored in the shop ID 345 included in the information ID 337, and the above mentioned “101” is stored in the content ID 346. The content for displaying the shop information display screen 500 shown in FIG. 6 is stored in the content 338.

In this manner, the information processing device 100 that has received the information transfer request transmits the content corresponding to the broadcast-transmitted advertisement 320 in accordance with the information transfer request format (411 and 412). The information processing device 101 that has received content from the information processing device 100 causes the display unit to specifically display the received content in the above manner. For example, the shop information display screen 500 shown in FIG. 6 can be automatically displayed.

As described above, the information processing device 102 has already acquired the content corresponding to the advertisement 320 (content recorded in the memory 130 of the information processing device 100). Therefore, the information processing device 102 does not need to acquire the content. Accordingly, the information processing device 102 does not perform the procedures following the checking procedure (408).

[Example of Communication]

FIG. 11 is a sequence chart showing an example of a communication process between the respective devices constituting the communication system 10 according to the embodiment of the present technology. The example of the communication process shown in FIG. 11 is developed by partially modifying the communication process shown in FIG. 10. Therefore, the same aspects as the communication process shown in FIG. 10 are denoted by the same reference numerals as those used in FIG. 10, and some of those aspects will not be explained below.

FIG. 11 shows an example of the communication process to be performed in a case where content recorded in the memory 130 of the information processing device 100 has not been acquired by either of the information processing devices 101 and 102. In the example of the communication process shown in FIG. 11, the information processing device 101 exists in the information transmittable range 31 of the information processing device 100, but the information processing device 102 does not exist in the information transmittable range 31 of the information processing device 100, as shown in FIG. 5. Also, the information processing device 102 exists in the information transmittable range 32 of the information processing device 101.

Furthermore, in the example of the communication process shown in FIG. 11, when receiving content, the information processing device 101 determines the current time to be a transfer start time, and determines not to restrict transfer.

As described above, the information processing device 102 has not acquired the content corresponding to the advertisement 320 (content recorded in the memory 130 of the information processing device 100). Therefore, the control unit of the information processing device 102 transmits an information transfer request to the transmission source (the information processing device 100) of the advertisement 320 (421 through 424). However, the information processing device 102 does not exist in the information transmittable range 31 of the information processing device 100. Therefore, the information processing device 102 transmits the information transfer request to the information processing device 100 via the information processing device 101 (421 through 424).

The control unit 120 of the information processing device 100 that has received the information transfer request transmits the content corresponding to the broadcast-transmitted advertisement 320 to the information processing device (the information processing device 102) that has transmitted the information transfer request (425 through 428). In this case, the information processing device 100 transmits the content to the information processing device 102 via the information processing device 101 (425 through 428).

As described above, when receiving the content (426), the information processing device 101 determines the current time to be a transfer start time, and determines not to restrict transfer. Accordingly, the information processing device 101 transfers the received content instantly to the information processing device 102 (427 and 428).

In the examples of communication processes shown in FIGS. 10 and 11, the information processing device 102 does not exist in the information transmittable range 31 of the information processing device 100. However, both of the information processing devices 101 and 102 might exist in the information transmittable range of the information processing device 100. In such a case, the information processing device 100 can transmit content to both of the information processing devices 101 and 102 through multicast (or multiple unicast).

[Example of Operation of an Information Processing Device (Transfer Source)]

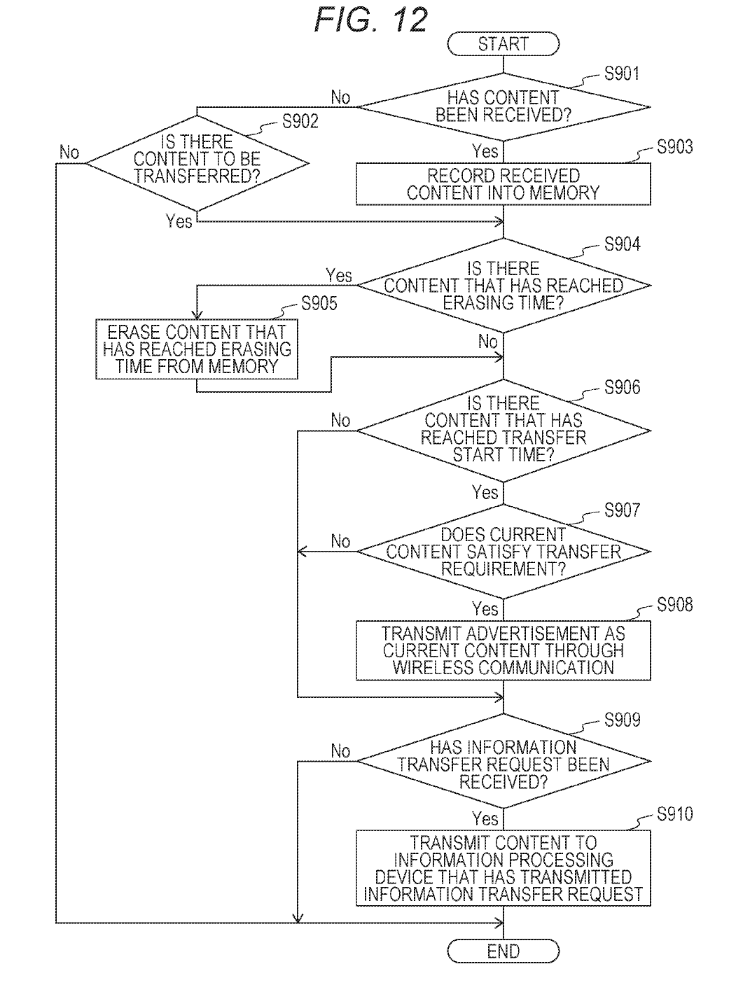

FIG. 12 is a flowchart showing an example of the processing procedures in a communication process to be performed by the information processing device 100 according to the embodiment of the present technology.

First, the control unit 120 determines whether content has been received (step S901). If no content has been received (step S901), the control unit 120 determines whether content to be transferred exists in the memory 130 (step S902). If there is no content to be transferred (step S902), the communication process comes to an end. If there is content to be transferred (step S902), on the other hand, the process moves on to step S904.

If content has been received (step S901), the control unit 120 records the received content into the memory 130 (step S903). In this case, the information accompanying the received content (the accompanying information being the respective portions of the information transfer histories [0] 334 through [n] 336 shown in b in FIG. 8, and the respective portions of the information ID 337, for example) is associated with the received content, and is also recorded into the memory 130.

The control unit 120 then determines whether there is content that has reached the erasing time (step S904). For example, a check is made to determine whether content determined to be restricted from transfer through transfer restriction determination is recorded in the memory 130 (step S904). If there is content that has reached the erasing time (step S904), the control unit 120 erases the content that has reached the erasing time from the memory 130 (step S905), and then moves on to step S906.

If there is no content that has reached the erasing time (step S904), the control unit 120 determines whether content that has reached a transfer start time exists in the memory 130 (step S906). If no content that has reached a transfer start time exists in the memory 130 (step S906), the process moves on to step S909. If content that has reached a transfer start time exists in the memory 130 (step S906), on the other hand, the control unit 120 determines whether the content that has reached a transfer start time satisfies the transfer requirement (step S907). If the content that has reached a transfer start time does not satisfy the transfer requirement (step S907), the process moves on to step S909. It should be noted that steps S906 and S907 are an example of the determination step of the claims. Steps S908 through S910 are an example of the transfer step of the claims.

If the content that has reached a transfer start time satisfies the transfer requirement (step S907), the control unit 120 transmits the advertisement as the content in a broadcast-like manner in accordance with the advertisement format (step S908).

The control unit 120 then determines whether an information transfer request has been received (step S909). If no information transfer request has been received (S909), the communication process comes to an end. If an information transfer request has been received (S909), the control unit 120 transmits the content corresponding to the broadcast-transmitted advertisement to the information processing device that has transmitted the information transfer request (step S910).

[Example of Operation of an Information Processing Device (Transfer Destination)]

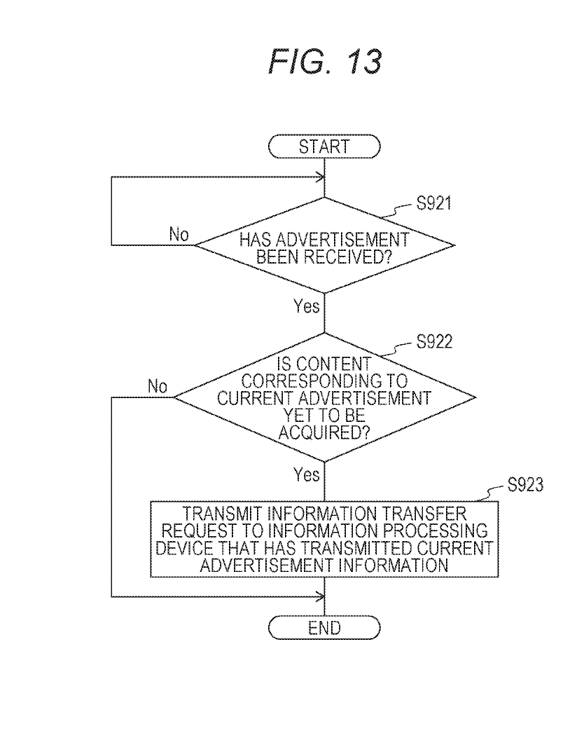

FIG. 13 is a flowchart showing an example of the processing procedures in a communication process to be performed by the information processing device 101 according to the embodiment of the present technology. In the example of the communication process shown in FIG. 13, an information transfer request for an advertisement transmitted from the content transfer source is transmitted to the transfer source. The communication process to receive the content corresponding to the information transfer request is equivalent to steps S901 and S902 shown in FIG. 12.

First, the control unit of the information processing device 101 determines whether an advertisement has been received (step S921). If the advertisement has not been received, the control unit continues the monitoring. If the advertisement has been received (step S921), on the other hand, the control unit of the information processing device 101 checks whether the content corresponding to the advertisement has been acquired (step S922).

If the content corresponding to the advertisement has been acquired (step S922), the communication process comes to an end. If the content corresponding to the advertisement has not been acquired (step S922), on the other hand, the control unit of the information processing device 101 transmits an information transfer request to the transmission source of the advertisement (step S923).

As described so far, according to the embodiment of the present technology, content can be provided at an appropriate time in a case where content (sales promotion information such as the information about the products being sold at a shop, or coupons) is provided to users through wireless communication. That is, a wireless system that can spread content in a store-and-forward manner can be realized.

For example, the information processing device 100 receives content (the shop information about the shop 11) as primary information from the access point 210 installed in the shop 11 shown in FIG. 4. In this case, the information processing device 100 records the received content into the memory 130 (shown in FIG. 2), and, when a predetermined condition is satisfied, spreads the content as secondary information through direct communication with another information processing device. For example, the information processing device 100 can transfer the received content as the secondary information to the information processing device 101, as shown in FIG. 5. Like the information processing device 100 that has received the content first, the information processing device 101 to which the content has been transferred can temporarily record the content into its internal memory, and transfer the content to yet another information processing device (the information processing device 102, for example).

As content transfer is repeated in the above manner, content can be appropriately spread. For example, as users carrying information processing devices move around, the content transmission range can be expanded. For example, content can be effectively distributed to specific users who are likely to be interested in the products being sold in a shopping mall, such as people actually visiting the shopping mall. That is, content can be provided at an appropriate time.

Here, the time when the predetermined condition is satisfied is determined to be a transfer start time, and is the time when content transfer is determined not to be restricted. As transfer restriction is determined in the above manner, unlimited spreading of content is prevented, and the information spreading range can be limited in accordance with a certain intention of the content provider. That is, the transmission range can be limited depending on the number of times forwarding has been performed, or the location.

In the above described examples of the embodiment of the present technology, a transfer start time or transfer restriction is determined based on the time, the location (a linear distance, a movement distance, or the like), the number of times transfer has been performed, or the like. However, such determination may be made, with buildings or shops as units being taken into account. For example, a movement range extending to the fifth shop counted from a neighboring shop may be set as the time when the predetermined condition is satisfied. In this case, the time when the information processing device reaches the neighboring shop is determined to be a transfer start time, and the time when the information processing device reaches the sixth shop is determined to be a time to restrict transfer.

Also, a movement range from another shop on the same floor in the same building to a shop on a different floor in the same building may be set as the time when the predetermined condition is satisfied. That is, transfer is not restricted in the same building. In this case, the time when the information processing device reaches another shop is determined to be a transfer start time, and the time when the information processing device moves out of the building is determined to be a time to restrict transfer.

Also, the period from the time when the user moves to another shop in the same shopping street to the time when the user moves out of the shopping street may be set as the time when the predetermined condition is satisfied. That is, transfer is not restricted in the same shopping street. In this case, the time when the information processing device reaches another shop is determined to be a transfer start time, and the time when the information processing device moves out of the shopping street is determined to be a time to restrict transfer.

Such determination taking into account building and shops as units can be made based on map data (such as map data for identifying buildings and shops as units) and location information acquired by the location information acquiring unit 115 (shown in FIG. 2), for example.

The embodiment of the present technology can also be applied in cases where some other information processing devices having wireless communication functions (such as personal computers, game machines, digital still cameras, or digital video cameras (camcorders, for example)) are used as the information processing devices.

It should be noted that the above described embodiment is an example for embodying the present technology, and the matter of the embodiment corresponds to the subject matter of the claims. Likewise, the subject matter of the claims corresponds to the matter under the same names as the subject matter of the claims in the embodiments of the present technology. However, the present technology is not limited to the embodiment, and various changes can be made to the embodiment without departing from the scope of the technology.

The processing procedures described above in the embodiment may be regarded as a method involving the series of these procedures, or may be regarded as a program for causing a computer to carry out the series of these procedures or a recording medium storing the program. This recording medium may be a CD (Compact Disc), an MD (MiniDisc), a DVD (Digital Versatile Disc), a memory card, or a Blu-ray (a registered trade name) Disc, for example.

The present technology may also be embodied in the structures described below.

(1)

An information processing device including:

a communication unit that receives and transmits content through wireless communication; and

a control unit that performs control to transfer the content to another information processing device from a location after reception of the content, the another information processing device existing in a predetermined range, the predetermined range being based on the location, a predetermined condition being satisfied at the location, the predetermined condition being based on the location of the first transmission of the content.

(2)

The information processing device of (1), wherein the control unit determines whether the information processing device exists at a location where the predetermined condition is satisfied based on information accompanying the content.

(3)

The information processing device of (2), wherein the control unit transfers the content to the another information processing device during the period from the time when the information processing device exists at a location where the predetermined condition is first satisfied till the time when the information processing device exists at a location where the predetermined condition is not satisfied.

(4)

The information processing device of one of (1) through (3), wherein the control unit determines whether the information processing device exists at a location where the predetermined condition is satisfied based on at least one of a first distance, a second distance, a first time, and a second time, the first distance being the distance from the location of the first transmission of the content, the second distance being the distance of movement of the information processing device from the location of the first transmission of the content, the first time being the time elapsed since the time of the first transmission of the content, the second time being the time elapsed since the time of the reception of the content.

(5)

The information processing device of (4), wherein, when at least one of the first distance, the second distance, the first time, and the second time is greater than a threshold value serving as a reference value, the control unit determines that the information processing device exists at the location where the predetermined condition is first satisfied.

(6)

The information processing device of one of (3) through (5), wherein, when at least one of the number of times the content has been transferred, the distance from the location of the first transmission of the content, and the time elapsed since the time of the first transmission of the content is greater than a threshold value serving as a reference value, the control unit determines that the information processing device exists at a location where the predetermined condition is not satisfied.

(7)

The information processing device of one of (3) or (6), wherein, when determining that the information processing device exists at a location where the predetermined condition is not satisfied, the control unit discards the content.

(8)

The information processing device of one of (1) through (7), wherein the control unit performs control to add a bonus to the content based on information accompanying the content.

(9)

The information processing device of one of (1) through (8), wherein the control unit transfers the content after associating history information with the content, the history information being for identifying the transfer source.

(10)

The information processing device of (9), wherein, when the history information associated with the content includes history information about the information processing device at a time of reception of the content, the control unit discards the content.

(11)

A communication system including:

a first information processing device that transfers content to a second information processing device through wireless communication from a location after receiving the content, the second information processing device existing in a predetermined range, the predetermined range being based on the location, a predetermined condition being satisfied at the location, the predetermined condition being based on the location of the first transmission of the content; and

the second information processing device that transfers the content to another information processing device through wireless communication from a location after receiving the content from the first information processing device, the another information processing device existing in a predetermined range, the predetermined range being based on the location, the predetermined condition being satisfied at the location.

(12)

A communication method including:

a determination step of determining whether a predetermined condition is satisfied at a location after reception of content, the predetermined condition being based on the location of the first transmission of the content; and

a transfer step of transferring the content to another information processing device when it is determined that the predetermined condition is satisfied at the location, the another information processing device existing in a predetermined range, the predetermined range being based on the location.

(13)

A program for causing a computer to carry out:

a determination step of determining whether a predetermined condition is satisfied at a location after reception of content, the predetermined condition being based on the location of the first transmission of the content; and

a transfer step of transferring the content to another information processing device when it is determined that the predetermined condition is satisfied at the location, the another information processing device existing in a predetermined range, the predetermined range being based on the location.

### REFERENCE SIGNS LIST

10 Communication system
100 to 102 Information processing device
111,113 Antenna
112 First communication unit
114 Second communication unit
115 Location information acquiring unit
120 Control unit
130 Memory
141 Display information input/output unit
142 Display unit
151 Operation information input/output unit
152 Operation accepting unit
161 Imaging information input/output unit
162 Imaging unit
171 Sound information input/output unit
172 Sound input unit
173 Sound output unit
180 Clock
190 Bus
200 Information providing server
210 Access point
211 Antenna
212 Communication unit
220 Location information acquiring unit
230 Control unit
240 Memory
251 Display information input/output unit
252 Display unit
261 Operation information input/output unit
262 Operation accepting unit
271 Ethernet input/output unit
280 Bus

1. An information processing device comprising:
a communication unit configured to receive and transmit content through wireless communication; and
a control unit configured to perform control to transfer the content to another information processing device from a location after reception of the content, the another information processing device existing in a predetermined range, the predetermined range being based on the location, a predetermined condition being satisfied at the location, the predetermined condition being based on a location of first transmission of the content.

2. The information processing device according to claim 1, wherein the control unit determines whether the information processing device exists at a location where the predetermined condition is satisfied based on information accompanying the content.

3. The information processing device according to claim 2, wherein the control unit transfers the content to the another information processing device during a period from a time when the information processing device exists at a location where the predetermined condition is first satisfied till a time when the information processing device exists at a location where the predetermined condition is not satisfied.

4. The information processing device according to claim 1, wherein the control unit determines whether the information processing device exists at a location where the predetermined condition is satisfied based on at least one of a first distance, a second distance, a first time, and a second time, the first distance being a distance from the location of the first transmission of the content, the second distance being a distance of movement of the information processing device from the location of the first transmission of the content, the first time being a time elapsed since a time of the first transmission of the content, the second time being a time elapsed since a time of reception of the content.

5. The information processing device according to claim 4, wherein, when at least one of the first distance, the second distance, the first time, and the second time is greater than a threshold value serving as a reference value, the control unit determines that the information processing device exists at the location where the predetermined condition is first satisfied.

6. The information processing device according to claim 3, wherein, when at least one of the number of times the content has been transferred, the distance from the location of the first transmission of the content, and the time elapsed since the time of the first transmission of the content is greater than a threshold value serving as a reference value, the control unit determines that the information processing device exists at a location where the predetermined condition is not satisfied.

7. The information processing device according to claim 3, wherein, when determining that the information processing device exists at a location where the predetermined condition is not satisfied, the control unit discards the content.

8. The information processing device according to claim 1, wherein the control unit performs control to add a bonus to the content based on information accompanying the content.

9. The information processing device according to claim 1, wherein the control unit transfers the content after associating history information with the content, the history information being for identifying a transfer source.

10. The information processing device according to claim 9, wherein, when the history information associated with the content includes history information about the information processing device at a time of reception of the content, the control unit discards the content.

11. A communication system comprising:
a first information processing device configured to transfer content to a second information processing device through wireless communication from a location after receiving the content, the second information processing device existing in a predetermined range, the predetermined range being based on the location, a predetermined condition being satisfied at the location, the predetermined condition being based on a location of first transmission of the content; and
the second information processing device configured to transfer the content to another information processing device through wireless communication from a location after receiving the content from the first information processing device, the another information processing device existing in a predetermined range, the predetermined range being based on the location, the predetermined condition being satisfied at the location.

12. A communication method comprising:
a determination step of determining whether a predetermined condition is satisfied at a location after reception of content, the predetermined condition being based on a location of first transmission of the content; and
a transfer step of transferring the content to another information processing device when it is determined that the predetermined condition is satisfied at the location, the another information processing device existing in a predetermined range, the predetermined range being based on the location.

13. A program for causing a computer to carry out:
a determination step of determining whether a predetermined condition is satisfied at a location after reception of content, the predetermined condition being based on a location of first transmission of the content; and
a transfer step of transferring the content to another information processing device when it is determined that the predetermined condition is satisfied at the location, the another information processing device existing in a predetermined range, the predetermined range being based on the location.
